(19) United States
(12) Patent Application Publication
(10) Pub. No.: US 2008/0160152 A1
(43) Pub. Date: Jul. 3, 2008

(54) Weight management with sugars, insoluble hygroscopic substances, and water

(76) Inventor: Keith Earl Kenyon, Sherman Oaks, CA (US)

Correspondence Address: KEITH E. KENYON, M.D., 4501 NAGLE AVENUE, SHERMAN OAKS, CA, 91423, US

(21) Appl. No.: 11/648,960

(22) Filed: Jan. 3, 2007

(51) Int. Cl. A23L 1/05

(52) U.S. Cl. 426/573

(57) ABSTRACT

This disclosure is about making pastry without flour by combining sugar, a zero calories, zero glycemia, cellulosic dietary fiber gel called Z-Trim, water and mixing the three together to substitute for ordinary flour. It thus is formed into a batter that takes the place of a complex carbohydrate, or flour, which is a solid so cannot be a batter by itself. Any sugar can accomplish this but sucrose is the prime embodiment, however erythritol is a sugar alcohol of virtually zero calories, zero glycemia, so merits special attention. Protein powder including the isolates of soy and whey is also included but it is inferior to Z-Trim.

### CROSS REFERENCE TO RELATED APPLICATIONS

This is an effort to combine patent application No. 11/301,181, “Z-Trim Combined Directly with Erythritol”, Ser. No. 11/358,619, “Binding Virtually Zero Calories Saccharide-Type Bulk to Dietary Protein” Ser. No. 11/371,281, “Soy-Erythritol Compositions for Health”, Ser. No. 11/397,042, “Erythritol Suppression of Ghrelin”, Ser. No. 11/409,310 “Sweetening Erythritol by Permanent Magnet Means” and Ser. No. 11/586,749. “Enhancing Erythritol Ghrelin Suppression” into a new disclosure.

### STATEMENT REGARDING FEDERALLY SPONSORED RESEARCH/DEVELOPMENT

The present invention does not involve any form of federally sponsored research or development.

### BACKGROUND OF THE PRESENT INVENTION

The previous disclosures are mostly about using erythritol and certain hygroscopic substances to make substitute low calories cookies, but they failed to discuss the prime role that water played, including the elimination of flour-caused gluten. Z-Trim, a zero calories, zero glycemic cellulosic dietary fiber gel, played a role in this endeavor. The fact is the use of water as a prime ingredient to replace flour is novel with its inclusion of Z-Trim, yet this has failed to be incorporated by those skilled in the art. In a recent, Nov. 23, 2006, published patent application by Z-Trim Holdings, Inc., “Emulsified Liquid Shortening Composition Comprising Dietary Fiber Gel, Water and Lipid”, publication No. 20060263485, its inventors were concerned with using water, 30 to 80%, to emulsify lipids. However, the words flour or sugar were not mentioned once in this disclosure, and it was not intended to replace flour, including gluten, so using Z-Trim to eliminate flour and using any kind sugar to take up the slack with Z-Trim is novel.

This is surprising because sugars are among the commonest foods that have calories in them, yet sugars are among the easiest foods to make into lower calorie combinations by their ability to emulsify when brought into contact with a zero calories cellulosic dietary fiber gel and water. This also includes their separate ability to be brought into contact with protein powders and water although here the calorie reduction is less since the protein has calories unlike the dietary fiber gel and water, and because they require more protein than Z-Trim they are less sweet. These ingredients are then emulsified with water and baked with. Although water is the essential ingredient to conduct the emulsification, its vital role in the lower calorie benefit of the disclosures was not totally discussed but is now, and all kinds of sugar including sucrose, dextrose and fructose are included. Therefore the role of sugar, including common sugars, are included. The virtually zero calories sugar alcohol or polyol, erythritol previously took the forefront in the disclosures for its weight management capacity which is obviously greater, it being virtually zero calories.

Among the most ambitious programs to address the problem of making a zero calories food or cellulosic dietary fiber gel without erythritol, although with ordinary sugar, has been by the United States Department of Agriculture and its chemist George Inglett, Ph.D. The culmination of this federal effort resulted in the awarding of a patent concerning prebiotic cellulosic fiber in 1998, U.S. Pat. No. 5,766,662, which is herein incorporated by reference in its entirety. Dr. Inglett's patent was assigned to the United States Government and licenses awarded. This disclosure did employ the use of ordinary flour. Neither in the forgoing patent nor others associated with the name Z-Trim, the name coined by Dr. Inglett, employed the use of the only sugar-type food which had the same number of calories (virtually zero) and zero glycemia, the polyol, erythritol. This polyol is being incorporated with Z-Trim in this disclosure as predominantly erythritol by weight, and the use of regular calories sucrose as predominantly sucrose in weight.

Erythritol is being used in this disclosure because it is virtually zero calories and has the ability to stimulate ghrelin suppression without calories, but every sugar can be used with Z-Trim to reduce its calories when used as a flour with water in baking. This includes the commonest sugars, sucrose, glucose and fructose.

This disclosure is being written in part to make more abundant the use of erythritol in ghrelin suppression. It is being written also to make the use of erythritol more abundant in cooking so that its virtually zero calories use in cooking can be greatly expanded upon. Using erythritol all by itself is certainly feasible but it is unable to be dominant in cooking and does not have the many uses of ordinary sugar including as a caramelizing agent. Rather erythritol is used only as a sweetener for other foods or substances even though it is only 70% as sweet as sucrose. Its lack of being a hygroscopic sugar also prevents it being cooked with in the manner of hygroscopic sucrose. It is also sparingly soluble in water and from baking temperatures (350° F.) it tends to come out of solution on cooling. This may be due to its profound endothermic nature and its low solubility but there may be other factors.

Thus erythritol cannot act like other sugars in cooking because of its special properties. Most of the art surrounding cooking with erythritol is based on the disclosure by Cargill in making confections as is portrayed in published patent application No. 2004008661-5, “Reduced Calorie Confectionary Compositions”, in applying bulk erythritol to FOS (fructo-oligosaccharide) and 25% fat, attempted to overcome this problem. But this application could never be accomplished because erythritol's prime use was to render the recipe sweeter, but erythritol's cooking problems rendered it not desirable. Therefore erythritol's prime use is as a pure sweetener, such as with coffee or soft drinks where it competes with xylitol, where it has caries prevention, but lacks xylitol's hygroscopic nature so is more difficult to have as a coating for chewing gum. What has been left open is using erythritol as a flour, something that no sugar has accomplished, but this disclosure will open the way for it and the other sugars to be so used.

Finally since water is more or less half of the make-up of the “flour” we will produce, the type of water to be used will depend upon the user's taste, but either tap water or water that is filtered may be used.

This invention is designed, among other things, to overcome the deficiencies of previous applications and inventions by employing new means to enhance sugars used in cooking so that sucrose, glucose and fructose can be used with water to reduce calories and eliminate gluten, and erythritol will be available as a virtually zero calories, zero glycemic entity and to be in greater volume in the small intestine for ghrelin suppression from a non-caloric source.

### BRIEF SUMMARY OF THE INVENTION

Although the use of any water can be part of this disclosure, filtered water is best used. The batter made in this disclosure is novel in that it consists of two parts. The first part, which is the novel part, is that a first batter is made composed of sugar, Z-Trim and water mixed together. The usual first batter is that which fat and eggs are included, and ordinary flour is used but not here. The amount of water will vary amongst the different sugars, but it will not vary by much and in the case of sucrose will approximately be 0.10 Z-Trim, 0.90 sugar and ±1.0 water on the low Z-Trim side but not much more than 0.15 Z-Trim, 0.85 sugar and ±1.0 water average, and maximally 0.20 Z-Trim, 0.80 sugar and ±1.0 water on the high side with the sugar having the same index of sweetness as sucrose in case another kind of sugar is used. Although the water is placed at ±1.0, less may be used in case a particularly dry product is desired, but non-erythritol sugar will have more calories. In the event that protein isolate is opted for, the figures are minimally with respect to protein, 0.30, and thereby 0.70 sugar and ±1.0 water approximately.

With erythritol there is a difference since it takes more Z-Trim to make a pastry and a little less water than the average for sucrose. For example, erythritol is 81.5% and Z-Trim 18.5% in a premix that can be packaged. In this way at cooking, before other ingredients are added, the same amount of water compared to erythritol may be added to the premix and a preliminary batter prepared in this manner. In this way not only is the “flour” of zero calories, but it has been added to with water which is also zero calories. Considerable extra cost is endured to have zero calories with erythritol even though there are reduced calories with sucrose because of the dilution with water but not as much as erythritol.

One thing more, erythritol is unlike the common sugars when it comes to cooking with it. There is no problem with common sugars since they remain in solution. With erythritol it is presumed that flour interferes with its staying in solution on cooling down. When flour is missing from the cooked mix, erythritol tends to stay in solution, and there is no solidified erythritol appearing on its cooling down.

All sugars do not need to be cooked with but can be eaten with things that are eaten raw. Thus the sugars of this disclosure need not be baked any differently than they do with ordinary flour. Butter or fat, eggs and other ingredients that accompany flour and sugar in pastries do not need lengthy times baking. Therefore, erythritol, common sugars sucrose, dextrose and fructose, and others do not need any more time to cook. Rather they just need to be baked long enough to render them firm and not crumbly.

This virtually solitary role is not the role that sugars ordinarily take since they are simple carbohydrates, are sweet, and they do not need to have Z-Trim added to be edible. They are water soluble and are used ordinarily in recipes when sweetening is desirable. Usually these are desserts or sweet snacks and confections. Flours may have a role in these in the form of pastries. These are mostly complex carbohydrates that can be of many different kinds, rye, oats, barley, wheat, rice, corn, soy, etc. These are ordinarily not sweet or edible by themselves raw, as sugars are, but can be baked with to render the cooked substance edible. They are therefore complex carbohydrates that are baked with to be rendered edible and may contain gluten. In this disclosure sugars with calories also are able to be mixed with Z-Trim or a hygroscopic protein powder and an approximately equal to the combination's weight of water, and the ingredients formed into a batter. In such a batter there would be calories but not from the water so included or the Z-Trim. Ordinarily it would not be feasible to use simple carbohydrates to replace the complex ones but in the case of using Z-Trim there is, if one wishes the “flour” to be virtually zero calories or in case where calorie-containing sugars are used, greatly reduced calories. Also eliminated are gluten and other harmful ingredients in flour.

Thus erythritol would be desirable because it is zero calories, zero glycemia, but what type of substance would it be combined with to render it a “flour” without the inclusion of calories from ordinary flour? Erythritol has two things going for it in this capacity. It is sparingly soluble in water and it is non-hygroscopic. This enables it to be combined with the exceedingly hygroscopic dietary fiber gel, Z-Trim. Z-trim is so hygroscopic that it will only need as little as 0.185 part Z-Trim to 0.815 part erythritol. On the other hand, when Z-Trim is replaced by soy protein isolate, it takes approximately 30% or more ISP. With Z-Trim it can have 0.815 part weight of water added to it (the weight of the erythritol) before the start of cooking because Z-Trim is sufficiently hygroscopic that it can hold the batter so formed, and with Z-Trim you need to cook long enough to render the pastry together and not crumbly. Sucrose has an even greater affinity for Z-Trim and makes an ideal batter, and a smaller amount of Z-Trim can be used and more water and even less time needed to cook.

Now it may be thought that you can change the proportions a bit and you will still have a workable batter, but you cannot change them much and still have it work the way it should, with water added, and still be sweet enough. This is the key point, if the water is added it still keeps the pastry sweet enough. Add a little less water if the pastry is too moist. Adding water is also desirable since it lowers the overall cost if it doesn't detract from the baked product, but the ingredients must be close to Z-Trim 0.1-0.15, sugar 0.85-0.90 and water ±1.0, for the most effective formula. The pastry will be able to be sold also if the consumer is sensitive to gluten or other allergic ingredients confined to flour. It is already reasonably sweet with the water added because it is more than a third sugar with the water added when combined with sucrose.

Of course this is also a novel way to use Z-Trim in pastries in which you only use, for example, sucrose and Z-Trim, there being no need to add the ordinary flours such as wheat, rye, soy, etc. You would simply combine Z-Trim with whatever sugar you wish and go from there. For example, you could combine as much as sucrose 85% and Z-Trim 15% and add water in a weight that equals the combined weight of Z-Trim and sucrose. You could also use glucose and xylitol the same way. In other words, any sugar that is as sweet as sucrose will work with this formula, but erythritol, although not as sweet, is the only sugar that has zero calories. It makes no difference how much water is present calorie-wise when Z-Trim and erythritol are used, only sweet-wise since the more water there is, the less sweetness, but it is important calorie-wise when other sugars are present since the water and Z-Trim offer no calories but the sugar, apart from being erythritol, adds calories as well as being sweet. Therefore, since the more that water is evaporated in heating with respect to, for example, sucrose, the higher the calories of the “flour” would be and the sweeter it would be. The sweeter the pastry, the less water is present, but since there is no ordinary flour, we can have a substantial amount of water. The virtually zero calories batter containing erythritol is what we are seeking to make into various kinds of bakery products as a prime example, and the more water we can use up to a point, the cheaper it is, although it is far less expensive to use common sugars.

Cookies, discrete formable ingredients that are made into small formed entities, are chief amongst these uses. This way the batter can be approximately half water, have low calories, be formed into cookies that have fewer calories and are the most cost effective with respect to using Z-Trim and sugar. If you use erythritol the calories are even less. The two solids can be packaged together dry, and water mixed in at the point of use which is one of the novel parts of this disclosure, since water is essential to the batter. The combination of ingredients can vary but it would be increasingly more money to make them with more Z-Trim. The higher the amount of Z-Trim, the more cost, and they would be less sweet.

Thus erythritol does not have the maximum capability to act by itself in food preparation because its crystalline nature does not dissolve well in water and it is non-hygroscopic. Since it is a sugar alcohol and will taste like sugar if used this way it needs to eliminate its sweet taste in those cases where it is not an advantage as it is in pastry. While there are a number of ways to do this, the use of vinegar is the cheapest way, and we will discuss this in more detail.

This disclosure is in part to expand the use of erythritol, besides being a sweetener, to a substance that is capable of taking the place of ordinary flour and ordinary sugar so that its free calorie aspect can penetrate culinary products. The formula 185:815 (Z-Trim:erythritol) or its near approximation, without water, and weight of water equivalent to the weight of erythritol added, can be used wherever this flour is used to replace ordinary flour and sugar, but its unique ability to react with water, which is novel with Z-Trim, is the reason why erythritol and all other sugars can incorporate nearly the same amount or the same amount of water as solids into a batter. Although erythritol brings zero calories to the mix, other sugars will have reduced calories with the water added.

Erythritol, as well as other sugars, is the dominant ingredient but it takes Z-Trim to complement it and make it able to be used in baking without erythritol's inherent loss of remaining in solution and partial precipitating out if used alone. We can use erythritol to enhance ghrelin suppression so we will make the substance doubly valuable in weight management. This is its ability to suppress ghrelin formation after it has left the stomach and gone deep into the small intestine. Whereas, ordinary food suppresses ghrelin formation, carbohydrates the most, followed by protein second, and fat a poor third, these foods contain calories, yet erythritol virtually has no calories yet suppresses ghrelin.

Erythritol or other sugars being sweet when used as a flour for a specific un-sweet recipe, care must be taken to render them un-sweet in this situation. In many recipes many may like to use erythritol as is. In those cases where it is obviously too sweet, a teaspoonful of vinegar per pound of batter may be all that is needed. This will apply to other sugars also.

Erythritol has special problems in cooking. The problem with erythritol's use at high temperatures is its intrinsic nature to fall out of solution during cooling. This results in its depositing plaques of hard erythritol when it is cooling. It is something that this disclosure seeks to avoid by emulsifying it with insoluble hygroscopic agents, especially Z-Trim, and water, in a batter before cooking. It is thought that keeping the ordinary flour out of the recipe gives erythritol the maximum ability to keep in solution during cooling. Erythritol can be used by itself for ghrelin suppression besides as a table sweetener. It can be used as a sweetener for chewing gum, but one would have to chew many pieces to get a dose of it, although it has the added benefit of being an anti-caries ingredient. It could be used with a fluid such as water to make a sweetened drink. Various kinds of synthetic flavorings can be used depending on the wishes of the consumer as is the case with all sugars.

Although we will ordinarily package the ingredients in the case of erythritol as 0.185:0.815, Z-Trim:erythritol, it can be packaged, within limits, in any amount desired and can even be sold as separate packages with recipes attached as long as it is more erythritol than Z-Trim. Water then can be added at the point of use, tap water, filtered, or brand name waters. Furthermore, in order to make cookies, the limit of water is equal to the weight of the two solid ingredients. Z-Trim and sugar of any kind is approximately the same weight as water.

This invention in part is to use erythritol so as to render it 81.5% solid erythritol in a dry package and Z-Trim 18.5%. Then water is added at the point of mixing a batter with the final batter including butter and eggs, to make cookies, but water cannot be more than the weight of erythritol for cookies and other baked products if the user wants the lowest calories but sweetest result. This means that there would be enough erythritol present for it to exert a reasonable suppression of ghrelin. This disclosure in part is to take ghrelin-suppressing erythritol and make it as much erythritol-content in cooking with it as is reasonably possible and still keep the quality in cooking. It is understandable to expect erythritol to be able to work by itself but as described above, this greatly limits its use, which if correctly made can be used in every phase of eating and snacking with good quality compared to sucrose as the standard. It is the intent in part of this invention to have erythritol be able to work as a virtually zero calories substance but in large amounts. It therefore must be combined with Z-Trim. In this way they can be packaged together in a combined form. Z-Trim forms a hygroscopic-induced emulsion, a substance that absorbs many times its own weight of water. Then when erythritol being non-hygroscopic is added, the hygroscopy of the added ingredient compensates for this. Also erythritol being non-hygroscopic means that it is more readily miscible dry with cellulosic dietary fiber gels such as Z-Trim, than are other sugars. Common sugars including sucrose, being mostly hygroscopic are anyway far less hygroscopic than Z-Trim so can do nearly as well as erythritol in this.

The features of the present invention which are believed to be novel are set forth with particularity. The present invention, both as to its organization and the manner of operation, together with the further objects and advantages thereof, may be best understood by reference to the following exemplary and non-limiting detailed description of the invention, wherein;

### DETAILED DESCRIPTION OF THE PREFERRED EMBODIMENT NO DRAWINGS

The preferred embodiment of this disclosure is to use sucrose and proportionate it as 0.85:0.15:±1.0 (sucrose:Z-Trim:water). The same can be done with dextrose and fructose or any combination of sugars or sugar alcohols. The ingredients can be changed as long as the Z-Trim remains at 20% the sugar or less. Also the Z-Trim cannot go much below 10% of the sugar or it will not lend itself to making a batter with the addition of water. Therefore the range of this preferred embodiment would be 0.9:0.1:1.0 (sucrose:Z-Trim:water) and include all the variables of sucrose and Z-Trim between 0.9:0.1 and 0.8:0.2. The first or novel batter is made according to this invention before or after the fat and eggs are added into what would be a second batter but both batters are ultimately in the same bowl and there is no flour or gluten. The time of cooking in this regard is important in order to optimize the combination of sweetness and calories. The longer it cooks, the sweeter it is and the more calories are included therein because of the evaporation of the water. Thus the time of cooking is to be optimized with this embodiment. It is not necessary to bake with this embodiment longer than the time it takes to bind the parts together.

Another embodiment of this disclosure is to mix erythritol with Z-Trim as follows: 0.815 erythritol, 0.185 Z-Trim or their approximation, by weight. Then before use, add by weight approximately 0.815 water and mix into a batter. There is no ordinary flour in this disclosure and this batter of Z-Trim, sugar alcohol and water is again novel. With respect to using erythritol, the length of time for cooking presents no calorie change as it is zero, but there is a gain in sweetness. Any water is usable including bottled water and filtered water, although mineral or artesian water is preferred by some.

This embodiment allows for enough Z-Trim to facilitate emulsification of the two, but leaves mostly erythritol, in the embodiment, to dictate the sweetness of the mixture, and render the mixture virtually zero calories. Both of these ingredients are capable of being used alone but their use together must be heavy on the erythritol. On careful evaluation the optimum ratio of erythritol:Z-Trim is 0.815:0.185. Then water equal to the weight of erythritol is added and mixed to make a batter. This is below the maximum water, ±1.0, but that is because of the nature of erythritol and Z-Trim. This allows for the maximum amount of erythritol to be present, therefore the maximum sweetness. Dropping the Z-Trim to 0.10 or even lower will not allow the sweetness of the mixture to be noticeably greater and will render the batter of the two with water added, not workable. Increasing the Z-Trim to above 0.185 becomes more expensive due to the relative increase in cost and you will lose any semblance of using sweet enough erythritol at ratios below 0.60. At 0.40 Z-Trim, erythritol will not be able to function sweet enough. The 0.815:0.185, erythritol:Z-Trim, mixture is of optimum sweetness coupled with water, 0.815, and is the preferred mixture for cookies and baked goods using erythritol. The fact that there is no ordinary flour in the recipe leads to erythritol staying in solution while the cookies cool.

On the other hand sugar may be desired to lose its sweetness in certain applications and this can be accomplished by adding a small amount of a non sweetening agent such as vinegar in one teaspoonful per pound amounts. In the event you want the erythritol to be sweeter than erythritol is naturally, then a sweetening agent such as sucralose can be added. Sweetening or non-sweetening agents can be added to the batter with instructions for doing so addressed.

There are reasons why erythritol lends itself to making a package with Z-Trim yet includes water at less than one and in fact equaling the weight of erythritol. It is that erythritol is not as sweet as the common sugars and it is zero calories so has to be taken in lesser amounts of total water than other sugars that have greater ability to react with Z-Trim. The non-hygroscopic nature of erythritol makes it capable of reacting with hygroscopic entities to be almost as capable as sucrose but to be zero calories. This is especially true with Z-Trim over protein powders and Z-Trim has no proteins like gluten.

A small permanent magnet can be included either to the outside or inside of the package, and it will enhance the taste of the erythritol and the other sugars. Also any kind of flavor can be added including distinct flour flavors.

Erythritol is not an ideal sugar to cook with compared to normal cooking sugars of which the best example is the disaccharide, sucrose. Ordinary cooking sugars have no trouble staying in solution. Nevertheless using this invention can enable the zero calories aspects of erythritol, especially with its ghrelin suppression, to make it easier for the obese individual to eat a lower calorie diet. Of course since caramelizing does not occur with erythritol, it cannot be used where that is the sole object. Notwithstanding, it is comparable to cooking with sucrose in many other ways but with Z-Trim, erythritol and water, the combination is virtually zero calories and remains in solution when cooling.

The main reason an insoluble mass that is hygroscopic, Z-Trim, can work with a larger mass of non hygroscopic erythritol, or a hygroscopic mass but small in comparison to Z-Trim's high hygroscopy like sucrose and glucose, is because the water insoluble hygroscopic mass can intersperse with the soluble non-hygroscopic or low hygroscopic mass and render the insoluble mass dispersed within the soluble mass with uniformity. Erythritol is less soluble and more non hygroscopic than most other sugars so it even has a more profound capacity to accomplish the forgoing, although ordinary sugars taking a little longer for complete mixing is understandable. Let us further discuss erythritol, which has the lowest hygroscopy.

We are attempting to include non-hygroscopic erythritol which has an endothermic or negative heat of solution and which ordinarily precipitates in part from the food it is being cooked with. It would appear that the way erythritol reacts with cooking is that this zero calories sugar has little use in cooking, in spite of its desirable calorie count. Therefore we have discovered and disclosed that by simply coating the erythritol particles with the dietary cellulosic fiber gel, Z-Trim, we get a product that is practical and will remain in solution during cooking and still remain in solution when cooled.

This is not to exclude other examples of hygroscopic insoluble materials having cellulosic dietary fiber gels or polypeptide composition as their make up too. This includes isolated soy protein which requires 30% ISP, 70% erythritol, and 80-100% of the two, water, all by weight, but such a mix has calories and is not as sweet. So also is the protein isolate of whey. By adding water to a mix of sugar and protein in a proportion of 2:1:3 (sugar:protein:water), you have calories but they are diluted by the water. These are diluted also by erythritol which has only the calories of the protein, and in the event that we use only Z-Trim and erythritol we have virtually zero calories.

This disclosure is in part to make erythritol even more useful to bake with, make frozen desserts with, and even cook with the sugar alcohol when such is indicated by the need of low calories with taste-acceptable food. By making erythritol a “flour”, it can do things better with this disclosure, including suppressing ghrelin deep in the small intestines. Since our ingredients Z-Trim, erythritol and water are ideally by weight 0.185, 0.815 and 0.815, they are almost the same ratio as is sucrose. Whereas erythritol by itself is a crystallized powder and can be used in that state, it needs something else added to render it incapable of falling out of solution. Cargill without knowledge of ghrelin suppression has sought to add inulin or FOS and its derivatives and other soluble sugars, but we have sought to render the crystalline sugar alcohol, “insoluble” with our non-sugar or Z-Trim addition. The fact that erythritol is not as sweet as ordinary sugar means that in non-sweet uses, erythritol may be more readily used in this capacity by souring it. Erythritol is able to be cooked with as a result of this disclosure. This disclosure in part is to take what amounts to mostly erythritol, but by adding 20% or preferably less Z-Trim, and we stress that less is more cost effective, but it must be enough to make a batter with the sugar, we will use it to make baked products. However, in addition we will make it so that you can make things like frozen concoctions more easily than with crystalline erythritol. Adding the Z-Trim to the erythritol is very easy due to the very hygroscopic nature of the Z-Trim and the non hygroscopic nature of the erythritol. Adding as little as 10% of Z-Trim, the two powders become readily miscible but cannot be baked with because they don't form a batter at that level of Z-Trim with water. However, when the mix is increased to 18.5 Z-Trim allowing for 81.5 erythritol, a batter can be formed as soon as more or less the same amount of water as erythritol is added. It is able to have meaningful zero calories ghrelin suppression as long as it is taken in large enough amounts to be worthwhile.

The fact that two mechanisms are in play here for erythritol and Z-Trim deserves comment. The first is the fact that due to both ingredients the resulting product is one of virtual zero calories and zero glycemia. The second is the fact that owing to the large amount of erythritol present the compound exerts an influence in the suppression of ghrelin. The question of what kind of ghrelin suppression becomes viable in the pathway of this disclosure notes only that ghrelin pathways are indeed complex and poorly understood. Deacylated ghrelin plays a role opposite that of acylated ghrelin in that the deacylated type opposes the action of the acylated which is the active form of ghrelin. Acylated ghrelin is manufactured by the body in about one fifth the amount of the deacylated type, but it is able to act without deacylated ghrelin, controlling appetite, although modifying it may be how it is done. Ghrelin is a 28 amino acid peptid, primarily synthesized by cells in the fundus of the stomach, and which stimulates the secretion of growth hormone. Its role in this disclosure does not differentiate the roles of the various components of the overall weight management scheme. This disclosure merely states that the resulting suppression of ghrelin by increasing osmolarity in the small intestine by erythritol does take place, modifying appetite, and we will await further research to find the roles of the various components. We will continue to use in this disclosure the generic ghrelin suppression to mean the net suppression of ghrelin, causing the appetite to be suppressed.

This invention in part is of using erythritol as a “flour” with Z-Trim in the mix so it becomes available in a goodly amount to enable us to suppress ghrelin formation when the erythritol encounters the small intestine and gets deep into the intestines where it is absorbed into the blood stream. It, however, is not ordinarily digested. Rather it forms an increased osmolarity which in turn suppresses ghrelin release. The problem is it is a non-calorie sugar and, ordinarily apart from a frozen or cool use, we should be limited in the ways it pan be used. This, however, is not true when one uses it as a “flour”, since the limited ways it can be used to cook with are greatly expanded because of the particularity of this disclosure. Instead of it being used only as a sweetener it now can be used to cook with in many recipes or parts of recipes to make them of fewer calories or of a lower glycemic index.

It will become obvious that the elements of this disclosure can be of great value in weight management even when erythritol is not cooked with and sucrose is with its ability to remain in solution not a question. Sucrose obviously Stimulates ghrelin suppression but it has calories. This disclosure will seek in part to include crystalline erythritol by itself in the suppression of ghrelin. Erythritol can be used as a a non-caloric substance by simply adding it to a substance needing sweetening like coffee or used with water flavored or unflavored. However, it is not a practical way to get a great deal of ghrelin suppression. Consumers are not likely to eat a lot of sugar by itself. On the other hand they will if it can be cooked with and not precipitate out on cooling. It will be better to add it to yogurt or ice cream, with modification by Z-Trim useful, and even add it to confections such as candy.

Ghrelin suppression is best done with erythritol when using Z-Trim with it. If used cold as a weight management substance it can be drunk by itself enabling the solution to be 100% ghrelin-suppressing in the small intestine. Z-Trim, even in such a small amount as 10%, will coat the erythritol crystals and herd the erythritol into the small intestine clumped into a much more intact conglomerate. This will enable the ghrelin to be suppressed more all at once, which will yield much more suppression per unit volume of intake. Nevertheless it still will be suppressed by erythritol by itself and non-caloric ghrelin suppression using only erythritol is covered by this disclosure.

The alternative way of using 100% crystalline erythritol is not ordinarily utilized by the overweight people in nearly the amount that this disclosure teaches, but this disclosure reserves the use of ghrelin suppression by erythritol in any way possible.

Finally it will be apparent that this invention can be used with ordinary flour or other ingredients by inclusion of it also in the batter. This of course cannot be in large amounts or it would undo the invention, its elimination of proteins like gluten and its practice of lower calories being made into pastries, but the taste factor can be accommodated where practical and stay within the limits of this invention. Also substances other than Z-Trim have a capacity to act with sugar, although they must be included at twice the amount as Z-Trim. Included amongst these ingredients are the protein isolates of soy and whey, which are useful to make flourless pastry with a taste that depends on the protein selected, Z-Trim being tasteless.

Also as long as erythritol by itself is used in a recipe to suppress ghrelin, it is part of this disclosure and also a special use that combines erythritol, one fifth of its weight in one or more amino acids, and 90% or more water in a spray that is spayed in the mouth whenever one is hungry.

With the noted exception of the suppression of ghrelin without calories, sucrose and the other sugars have the advantage over erythritol in being of greater availability and lower cost.

Pets including dogs and cats may have food using parts of this disclosure prepared for them.

While particular variations of the present invention have been described, it will be obvious to those skilled in the art that changes and modifications may be made without departing from my invention in its broader aspects of combining various sugars with hygroscopic cellulosic dietary fiber gel, Z-Trim, or a polypeptide substance such as ISP, in order for it to become a substitute for flour.

I claim:

1. The combination of a:
hygroscopic cellulosic dietary fiber gel, a sugar and water in a batter for baking pastry with fat and eggs but without flour.

2. The invention according to claim 1 wherein said hygroscopic cellulosic dietary fiber gel is Z-Trim.

3. The invention according to claim 1 wherein said sugar is sucrose,

4. The invention according to claim 1 wherein said sugar is the polyol, erythritol.

5. The invention according to claim 1 wherein said hygroscopic cellulosic dietary fiber gel composes 20% by weight or less compared to the weight of sugar.

6. The invention according to claim 1 wherein said hygroscopic cellulosic dietary fiber gel can be substituted for protein powders with higher weights than Z-Trim.

7. The invention according to claim 4 wherein said polyol, erythritol, being virtually zero calories, has the capacity to suppress ghrelin.

8. The invention according to claim 1 in which gluten is eliminated.
